(19) United States
(12) Patent Application Publication
(10) Pub. No.: US 2020/0364712 A1
(43) Pub. Date: Nov. 19, 2020

(54) PCN PAIRING SYSTEM AND METHOD

(71) Applicant: Extend Enterprises, Inc., New York, NY (US)

(72) Inventors: Andrew Jamison, New York, NY (US); Daniel Morrow, New York, NY (US); Guillaume Bouvard, New York, NY (US)

(21) Appl. No.: 16/877,173

(22) Filed: May 18, 2020

Related U.S. Application Data
(60) Provisional application No. 62/907,420, filed on Sep. 27, 2019.
(60) Provisional application No. 62/849,345, filed on May 17, 2019.

(51) Int. Cl. G06Q 20/40; G06Q 20/34

(52) U.S. Cl. CPC G06Q 20/401; G06Q 20/351

(57) ABSTRACT

Systems and methods are described herein for decoupling an account number from a physical or plastic card number (PCN), such as is typically used on credit, debit, gift cards, etc., by utilizing a virtual card number. In some aspects, an authorization request including a PCN may be received by a card conversion platform. A virtual card number, which the PCN may be registered to in a data store, may be determined. Based on comparing the authorization request with information associated with the PCN in the data store, the card conversion platform may determine to allow the authorization request. Upon allowing the authorization request, a modified authorization request, including the virtual card number, may be routed to a bank processing platform to approve or deny the authorization request based on a primary account associated with the virtual card number.

### CROSS REFERENCE TO RELATED APPLICATION

This application claims the benefit of U.S. Provisional Patent Application No. 62/907,420, filed Sep. 27, 2019, and U.S. Provisional Patent Application No. 62/849,345, filed May 17, 2019, the disclosures of which are incorporated by reference herein in their entirety.

### BACKGROUND

Use of a traditional plastic card printed with a 15 or 16 digit primary account number (PAN) at the point of sale (POS) of a card-accepting merchant remains the primary means by which credit card transactions occur today. The use of a Virtual Card Number (VCN), which is a credit card account number issued without the corresponding plastic card, is rising in popularity, particularly for online purchases and business-to-business (B2B) transactions. Since a VCN is issued without a physical plastic card, it lacks magnetic stripe, EMV chip (chip), or contactless functionality to enable it to interact with the point of sale terminals of brick and mortar merchants. This inability to transact at physical merchant locations remains a challenge to the wider adoption of VCNs.

### BRIEF DESCRIPTION OF THE DRAWINGS

Various techniques will be described with reference to the drawings, in which:

FIG. 1 illustrates an example system that processes a transaction using a virtual card number;

FIG. 2 illustrates an example system that converts a plastic card number to a virtual card number and accesses an account linked to the virtual card number, for example, through a merchant POS terminal;

FIGS. 3 and 4 illustrate an example process for authorizing a transaction using the system of FIG. 2;

FIG. 5 illustrates another example system that converts a plastic card number to a virtual card number and accesses an account linked to the virtual card number, for example, through a merchant POS terminal;

FIG. 6 illustrates an example process for authorizing a transaction using the system of FIG. 5;

FIG. 7 illustrates another example system that converts a plastic card number to a virtual card number and accesses an account linked to the virtual card number, for example, through a merchant POS terminal;

FIG. 8 illustrates an example process for authorizing a transaction using the system of FIG. 7;

FIG. 9 illustrates a more detailed example of a card conversion processing platform, such as described above in reference to FIG. 2;

FIG. 10 illustrates an example process for registering and paring an account with a virtual card number; and

FIG. 11 illustrates an example process for authorizing an account request.

### DETAILED DESCRIPTION

Systems and methods are described herein for decoupling an account number from a physical card number, such as is typically used on credit, debit, gift cards, etc., by utilizing a virtual card number to increase usability and security of the physical card number. The described system and techniques may be used as a standalone system, or may be used in conjunction with existing systems, such as standard credit card processing systems and even other virtual card number processing systems. In some aspects, a virtual card number (VCN) pre-processing platform or card conversion platform may register and pair a virtual card number (VCN), or an underlying account number of a client, such as a credit card account, a checking account, etc., with a selected plastic card number (PCN). Registration may include verifying information of the VCN, account holder, and the PCN or other number to be associated with the VCN. The PCN may be printed on a plastic card, as typical credit cards are created, or may be encoded onto a magnetic strip, chip, or other information carrying implement. In some aspects, by encoding the PCN onto a plastic card, without displaying the actual number (such that the PCN is only machine readable, either by a magnetic strip reader, chip reader, etc.), and/or excluding one of the PCN, Card Verification Value 2 (CVV2, which is the 3 or 4 digit security number printed on the card), or Expiration Date, security may be enhanced such that the card cannot be copied or improperly used by a merchant or others by visual inspection alone.

Once registered, the PCN may be associated with an underlying account, such as may be accessed by a virtual card number, and the association may be stored and accessed by the card conversion platform. In some examples, the VCN may be provided by a virtual card platform, such that the VCN is already linked to an underlying account. In other cases, the VCN may be generated by the card conversion platform and/or the virtual card platform and then linked to an underlying account, for example, manually by the client or via an interface with the banking institution responsible for handling the underlying account.

Once registered, the client may use the PCN at any normal merchant to purchase goods or services. The standard card processing systems, which may include a card authorization system and/or network authorization engine, may obtain the PCN from the merchant, and send the PCN to a card conversion platform, for example, based on the PCN being associated with instructions to send authorization requests to the card conversion platform. The card conversion platform may look up the PCN to determine if it is linked to a VCN. Upon finding a linked VCN, the VCN pre-processing platform may return the VCN to the card processing system, which may then use the VCN, in place of the PCN, to authorize the transaction with the account financial institution. In some aspects an existing virtual card platform or service may interface with and operate with the card processing system, to link the VCN to an account maintained by the account financial institution. In some cases, the PCN and/or the VCN may be associated with one or more controls or restrictions, such as spending limits, allowed merchants, etc., by the card conversion platform. The card conversion platform may enforce these limits when sending the VCN to the card authorization system.

The financial institution may then authorize (or reject) the transaction and send the response back to the card processing system. The card processing system may then interface with a virtual card platform and/or card conversion platform to exchange the VCN for the PCN, whereby the card authorization system may respond to the merchant. In this way, the VCN may never be exposed to the merchant or the client directly, to help increase security and prevent unwanted information breaches. In this way also, the underlying account information (VCN and account number) may be completely decoupled from the PCN itself, thereby enabling a holder of the account to place controls and monitor the PCN, for a variety of circumstances and scenarios.

In some aspects, the card conversion platform may provide an interface, such as a web interface or application, to enable clients to directly register and set controls on one or a number of PCNs. In some aspects, the VCN associated with the account may be used directly, for example, where the point of sale (POS) is not at a physical merchant. In yet some aspects, the described systems and techniques may be used to link one PCN to another PCN, in a similar way. For example, a temporary use card, such as may be used for traveling, may be associated with a dedicated credit card account or other account. In this scenario, a user may place one or a number of controls on the PCN, such as spending limits, types of goods and services that it can be used at, etc., time period during which the PCN is active or valid, to reduce the potential for unwanted purchases in the case the PCN is lost or stolen. In yet some cases, the application may enable direct control of one or various linked accounts, to enable a user to deactivate a PCN once it is discovered to be lost or stolen. In yet some examples, the application may be configurable to send notifications to a registered account holder, for example, when certain activity occurs with a certain PCN. This feature may beneficially enable an account holder to in real-time or near real time, verify or deny transactions to further enhance security and control over one or more PCNs.

In some examples, PCNs and the paring of them to VCNs may be advantageously used in a various corporate scenarios. In one example, Company Alpha may hire a large number of independent contractors, for engagements that can range from several weeks to several years in duration. During their engagement with the company, these independent contractors may often travel, and paying for the necessary travel arrangement may have presented issues with the company, the contractors or both, in the past. Because of the temporary nature of the relationship, Company Alpha is reluctant to issue these independent contractors a plastic company credit card for the contractors to use to pay for their travel expenses. However, these independent contractors do not typically have the financial means to use their personal cards to pay for these travel expenses up front and then wait to be reimbursed by the company. Company Alpha may have tried a number of ways to alleviate this issue in the past, including engaging an outside travel agency, or having the contractors book their own travel through the company's online accounts at a third party travel aggregator site. These approached, however, proved to be too expensive for the company, and still did not solve for incidental travel expenses such as gas and meals, did not adequately allow the company to ensure that the travel arrangements met the company's travel policy, and/or proved too hard to reconcile at the end of each month which travel expenses to book to which P&L.

The system and techniques described herein can be advantageously implemented to address one or more of these problems experienced by Company Alpha and/or the independent contractors. In one example, the company administrator can utilize its existing credit card program with its existing issuing bank. Rather than issue traditional plastic cards to the independent contractors through this program, however, the administrator signs utilizes the described systems to facilitate a VCN program through an issuing bank. Once set up with a VCN program, the administrator can obtain, from an issuing bank, a large number of inactive PCNs. Upon being hired, a contractor may be given from the administrator one of these inactive PCNs and instructions to download an application that interfaces with the card conversion platform. The administrator may send a unique VCN to the contractor via the application. The contractor then can download the application and take a picture of, scan, or enter a QR code or other identifier of the inactive PCN. Once the contractor is enabled with this VCN, she can use the application to pair an inactive PCN to the VCN she has received. The contractor can then make her travel arrangements online using the VCN, and in addition, can make purchases at physical merchant POS terminals, such as at gas stations, restaurants, or office supply stores, using the PCN that is paired to the VCN. The administrator may retain full visibility in real time to any authorizations and charges posted to the VCN, with the ability to suspend, increase the limit of the VCN, unpair the PCN from the VCN, or other actions that maximize control over the contractor's travel expenses. At the end of the month, the administrator can have an easier time reconciling the travel expenses to the proper P&L, and the contractor has been relieved of the need to personally pay for any expenses up front.

As will be described herein, a VCN can have various advantages over a traditional plastic card, such as, in some cases, increased flexibility. A business, for example, can manage thousands of unique VCNs, each with custom spend controls such as a spend limit, time period (such as time period the PCN is valid an active, such as indicated via hours, days, months, etc., time period beginning on activation, etc.), time of day the PCN is valid, merchant category codes, or other parameters that allow the business greater control and visibility over which charges end up on those VCNs. Some or all of these advantages can be better realized through an interface and system that allows VCNs to be used at POS merchants, linked through PCNs. Another advantage of the described systems and techniques is that, unlike a traditional plastic card, sensitive account information is not as easily visible or may not even be associated with the plastic card. In a traditional plastic card, the credit card number, security code, and expiration date of the card are all printed directly on the card. This makes it trivial to copy this information, and anyone with access to this card has the information needed to engage in fraudulent transactions. For this reason alone, businesses are often reluctant to give their employees and contractors access to a traditional plastic card. As further discussed here, pairing of a PCN to a VCN can offer potential solutions to (1) the inability to use a VCN at physical merchant locations and (2) the inherent security vulnerabilities of a traditional plastic card.

The following definitions are presented here to help clarify the meanings of certain terms as they are used in this document in accordance with various embodiments:

Traditional plastic card: a card that is used today (e.g., typical credit cards, debit cards, prepaid cards, etc.).

PCN: the “generic” card number printed on plastic. In some examples, PCN can be inactive, paired, disabled or canceled, as further explained here:

Inactive: A PCN that is not associated with any cardholder, credit account or credit line.

Paired: A PCN that has been paired to a virtual card number (VCN) or other account number or information, making it “live”.

Disabled: A paired PCN that is turned off for authorizations for a period of time or permanently. It may be re-enabled in the future in some examples.

Canceled: A PCN that is ineligible for pairing, potentially due to fraud. It may or may not have previously be inactive or paired.

Virtual Card Number (VCN): any alpha numeric identifier, of any number of digitals, that is uniquely identifiable, either alone or in combination with other information linked to an account associated with the VCN.

Prior to being paired to a VCN, in various examples, the PCN will be deemed inactive as it will not have any credit account or credit line associated with it, nor will it be associated with a cardholder. As such, prior to pairing to a VCN, these physical plastic cards can be safely and easily distributed at scale. For example, PCN cards could be distributed internally at companies via an administrator. Until a PCN is paired to a VCN to make it “live”, the PCN will be useless. In some examples, PCNs can be offered for purchase in a similar way that prepaid cards are sold today (e.g., j-hooks in convenience stores). This broader distribution can be facilitated by a third party (e.g., Blackhawk, Incomm, and the like). For Chip and PIN enabled PCNs, the PIN can be distributed in the same package as the PCN in accordance with some embodiments.

In various examples, PCN Bank Identification Number (BIN) ranges (or partial BIN ranges) can be owned by BIN sponsors (e.g., issuing banks, networks, and the like), and in some embodiments, may be configured with the network to route to the card processing platform prior to being deployed. A card conversion platform or VCN pre-processing platform can enable the pairing of a PCN to a VCN, as this platform, in some examples, may enable transactions on a PCN to flow through existing POS terminals without the need to reconfigure or change in any way those POSs, as will be described in greater detail below.

In some examples, the PCN can have one or more of a magnetic stripe, chip, Chip/PIN and contactless functionality, just like a traditional plastic card can have. However, in various embodiments, PCNs will not have one or more of the PAN (the primary account number), the Card Verification Value 2 (CVV2, which is the 3 or 4 digit security number printed on the card), Expiration Date, or the like, printed or visibly indicated on the card. In addition, in various embodiments, the new PCN will not have a card holder and/or company name printed anywhere on the plastic. The PAN, CVV1 or CVV2, Expiration Date, and the like can be encoded in the card via one or more of the magnetic stripe, chip, and contactless technology, and thus can still be readable by the merchant POS terminal.

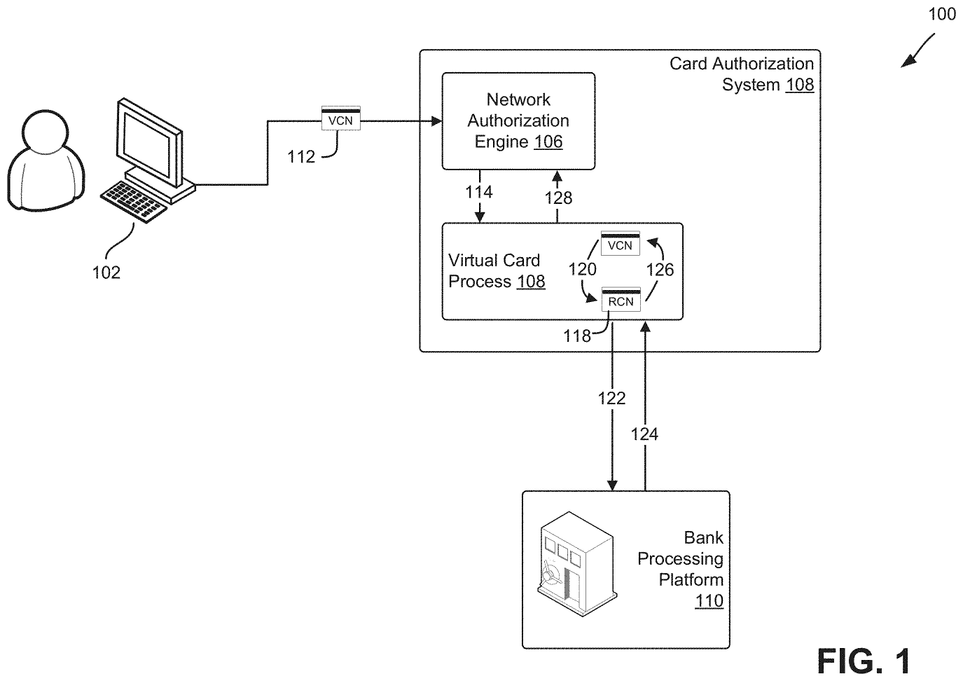

FIG. 1 illustrates an example of a virtual card number authorization system 100. System 100 may include a user terminal, such as a network connected computing device 102, in communication with a card authorization system 108. The card authorization system 108 may include a network authorization engine 106 and a virtual card process 108, which may interface with a bank processing platform 110. One or more card authorization system 108, network authorization engine 106, virtual card process 108, and bank processing platform 110 may be or include a process executing on one more computing devices, as known in the art.

As illustrated, a user, via a networked computing device 102, may input a VCN at operation 112, and associated authentication information (expiration date, billing address, zip code, and/or other information) for a transaction. The VCN 112 may be routed to a card authorization system 108. A network authorization engine 106 of the card authorization system 108 may, based on the VCN, route the request to virtual card process 108 at operation 114. The virtual card process 108 may convert the VCN to a registered account number or registered card number (RCN) 118, at operation 120, for example, based on records indicating an association between the VCN and the RCN. The virtual card process 108 may then send the authorization request message, with the RCN instead of the VCN, to an appropriate bank processing platform 110, at operation 122. The bank processing platform 110 may verify that enough funds are available in the RCN, and authorize the request (or reject the request if not enough funds are available or some other condition is not satisfied), and send the response back to the virtual card process 108, at operation 124. The virtual card process 108 may then convert the RCN back to the VCN, at operation 126, and send the response, with the VCN, back to the network authorization engine 106, at operation 128. The network authorization engine 106 may then send the response back to the user computing device 102, to indicate whether the transaction was approved or denied.

One of the primarily limitations with VCN system 100 is that it does not support transactions at merchant POS terminals, because the VCN cannot be processed by existing merchant systems. As such, while VCN system 100 may be utilized for internet based transactions, where a physical card is not needed, system 100 is not typically suitable for merchant POS type transactions.

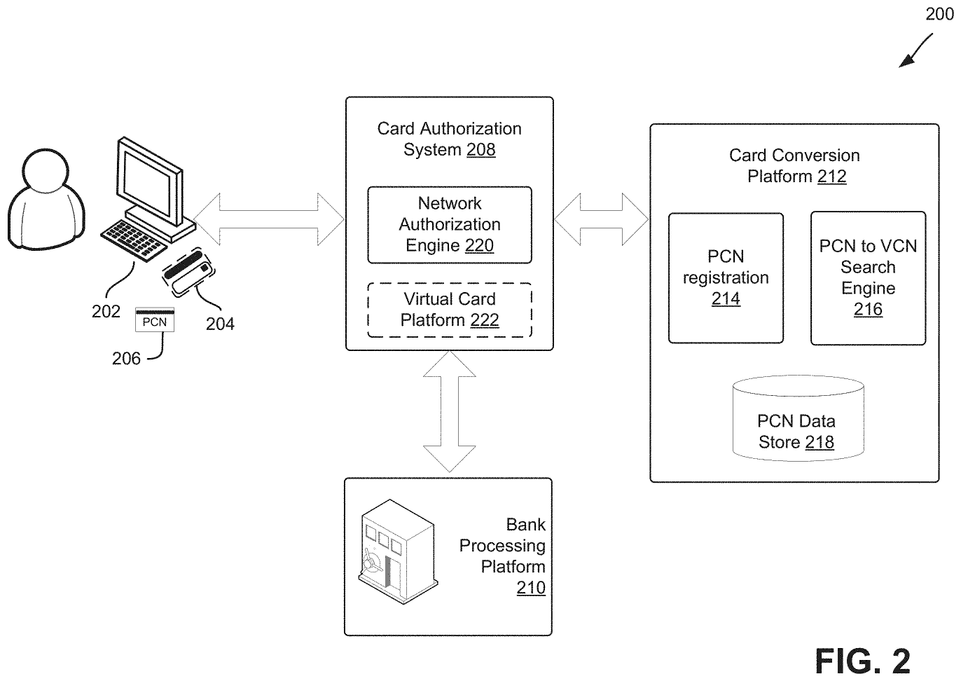

FIG. 2 illustrates an example system 200 for converting a plastic card number to a virtual card number and accessing an account linked to the virtual card number, for example, through a merchant point of sale (POS) terminal. In system 200, a card merchant POS terminal 202 may interface with a card authorization system or engine 208 to authorize and settle transactions using traditional plastic cards (e.g., credit cards, debit cards, gift cards, etc.). The card authorization engine 208 may include various computing devices interacting via one or more network connections, to facilitate the authentication, authorization and settlement of purchases using existing credit, debit, or gift cards, or even virtual card numbers, with one or more bank processing platforms 210, as is known in the art. In some cases, card authorization engine 208 may include a network authorization engine 220, as described above in reference to FIG. 1. In some cases, the card authorization engine or system 208 may also include a virtual card platform 222, which may interface with card conversion platform 212, to facilitate the use of a PCN 206 linked to a VCN, at POS terminal 202.

In some cases, the network authorization engine 220 may include a component or process executed by the card authorization system 208, and may direct transactions to the appropriate bank processing platform 210, for example based on BIN ranges of the account number (e.g., PCN, VCN, etc.) used for a given transaction. Via the described techniques, PCNs associated with the card conversion platform 212 may be associated with a certain range of BINs (e.g., part of the PCN), to enable the network authorization engine 220 to direct messages concerning transactions involving PCNs registered with the card conversion platform 212, to the card conversion platform 212 before sending a message to the bank processing platform 210. Via the described techniques, the operation of the network authorization engine 220 may be unchanged. By registering certain ranges of PCNs with the card authorization system 208, the network authorization engine 220 may simply direct the transaction messages falling in those ranges to the card conversion platform 212, just as it would direct other messages, based on BINs, to the appropriate bank processing platform (e.g., Visa, MasterCard, etc.).

The virtual card platform or engine 222 may, in some cases, generate and maintain VCNs, and upon receiving a VCN, interface with one or a number of bank processing platforms 210 (e.g., Visa, MasterCard, etc.) to access accounts linked to the VCN. The bank processing platform 210 may include any of a variety or collection of finical institutions, interacting with card authorization engine 208 via one or more network connections, as is also known the art.

System 200 may also include a card conversion platform 212, which may associate and link PCNs to VCNs, or other account identifiers, for authorizing and settling transactions. The card conversion platform 212 may include one or more computing devices connected through one or more network connections, which may interface with one or more card authorization systems 208 for facilitating transactions with PCNs linked to VCNs, as described herein. In some cases, the card conversion platform 212 may include one or more computing devices, and/or an application or computer executable code, for example, running on one or more hardware or virtualized computing devices or platforms. The card conversion platform 212 may include a PCN registration component or process 214, which may associate customer data, including one or more PCNs, with a VCN. In other examples the PCN registration process 214 may additionally or alternatively associated a PCN with another PCN, a primary account number (PAN), or other account identifiers, as will be described in greater detail below. The card conversion platform 212 may also include a PCN to VCN search engine or process 216, which may, upon receiving a PCN from card authorization network 208, search for a linked VCN, via accessing PCN data store 218. In some aspects, PCN data store 218 may be collocated with the card conversion platform 212, such as including information of linked VCNs duplicated from a virtual card engine 222 of the card authorization system 208.

In the example illustrated, a user may interact with a merchant POS terminal 202, who may scan or obtain information from a plastic card having a PCN 206 via a magnetic stripe or chip reader 204. The PCN may be sent to a card authorization system or network 208, which may check the BIN range on the card, and may recognize that any authorizations associated with the PCNs within that BIN range are to be routed by the network 208 to the card conversion platform 212. Upon receiving an authorization request message from the card authorization system 208 for the requested transaction, card conversion platform 212 can then modify the transaction message, swapping out the PCN details (e.g., 16 digit card number, expiration date, and the like) for the VCN details (e.g., 16 digit card number, expiration date, and the like), for example using a PCN to VCN search engine 216 accessing a PCN data store 218. The modified message can be re-submitted to the card authorization system 208, which in turn interfaces with the bank processing platform 210 to authorize the transaction, for example utilizing or interfacing with a virtual card platform 222. In some examples, the credit limit, or other limits placed on the VCN can be checked and enforces by the card conversion platform 212, the virtual card platform 222 and/or the bank processing platform 210, to determine whether the transaction should be authorized. The authorization response message, generated by the bank processing platform 210 likewise can flow back through virtual card platform 222 and the card conversion platform 212 and back through the network authorization engine 220 to the merchant acquirer 202, to indicate whether the transaction was approved or denied.

As the addition of the card conversion platform 212 can add an additional loop through the network authorization engine 220, increasing or maintaining processing and network speed can be beneficial to avoid a network timeout limit, which can be 30 seconds in some examples. As such, in various embodiments, there can be one or more speed enhancements that may be applied. For example, in some cases, card conversion platform 212 can be collocated with the card authorization system 208, and/or the entire PCN/VCN pairing database (e.g., PCN data store 218 and/or PCN to VCN search engine 216), can be stored in memory and can be read-replicated for the highest availability and fastest lookup possible. Programming language, databases, and hardware can be selected in some examples for maximum throughput and concurrency. Some or all messages and actions can be logged in various examples.

In some aspects, the pairing mechanism can rely on existing VCN technology to generate the VCNs that get paired with the PCN, such as virtual card platform 222 provided by or interfacing with the card authorization system 208. In this example, the card conversion platform 212 may obtain or access VCNs from a PCN data store 218, which may be populated by a virtual card platform 222, as may be utilized by card authorization system 208.

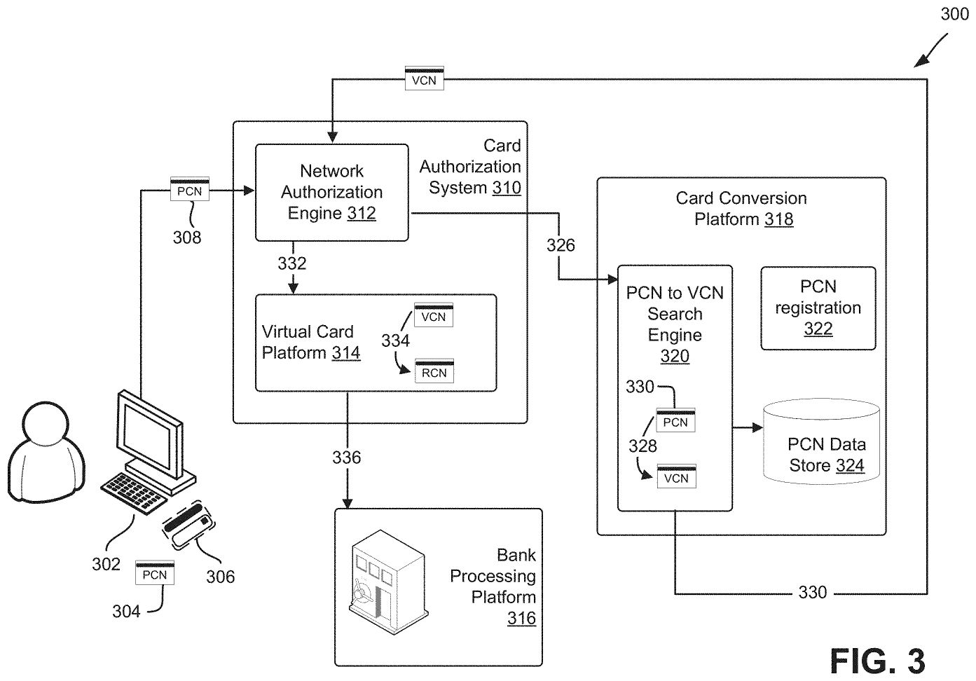

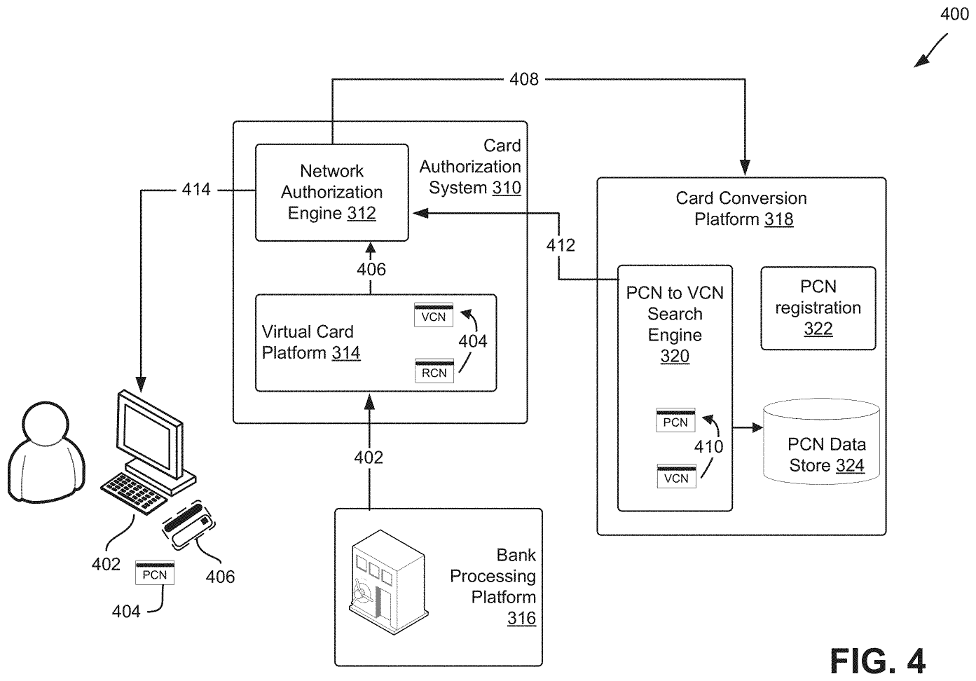

FIGS. 3 and 4 illustrates example processes of account authorization using a card conversion platform, such as implemented in system 200, described above in reference to FIG. 2. One or more of authorization system 310, network authorization engine 312, virtual card platform 314, bank processing platform 316, card conversion platform 318, PCN to VCN search engine 320, PCN registration 322, and/or PCN data store 324 may include one or more aspects of similar named components of system 200 described above, and for the sake of brevity, will not be described again here.

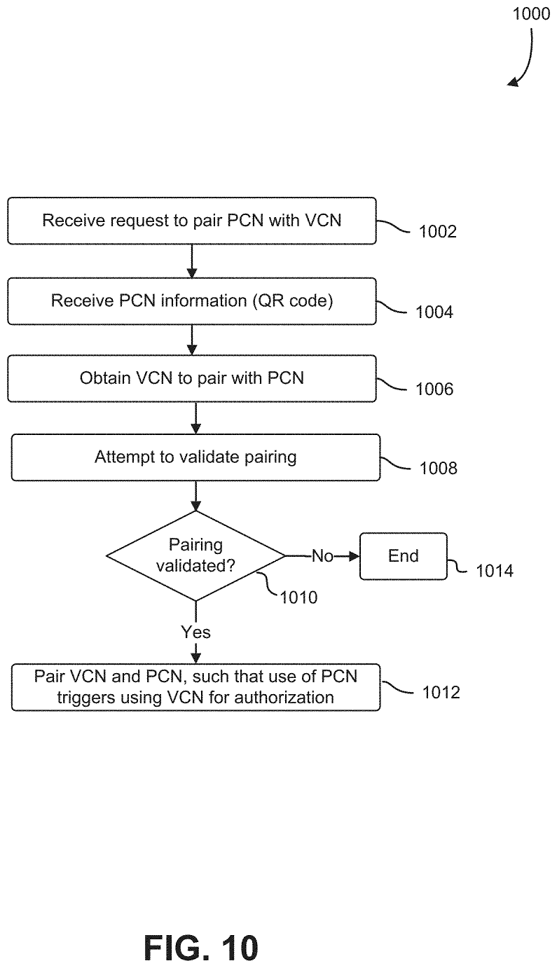

FIG. 3 illustrates an example process 300 for sending an authorization request to a bank processing platform, such as bank processing platform 314. This process assumes that a PCN has already been registered with the card conversion platform 318 and that it has been associated with a VCN. An example process for registering a PCN will be described in greater detail below in reference to FIG. 10. The example authorization flow 300 begins at a merchant 302 when the PCN 304 is physically used to make a transaction—which in various examples can be through a magnetic stripe swipe, an EMV chip dip, a contactless tap, or similar purposed device 306. The merchant POS terminal 302 can capture the PAN, CVV1/CVV2, and expiration date from the PCN and can transmit this data, along with transaction metadata, at operation 308, to the merchant's credit card acquiring processor, such as may be represented by card authorization system 310, such as in a first ISO8583 formatted message. This first ISO8583 message may be referred as the first authorization message in this example. In turn, the acquiring processor/system 310 can transmit this first authorization message to the correct credit card network, based on the some or all (e.g., initial) digits of the PCN.

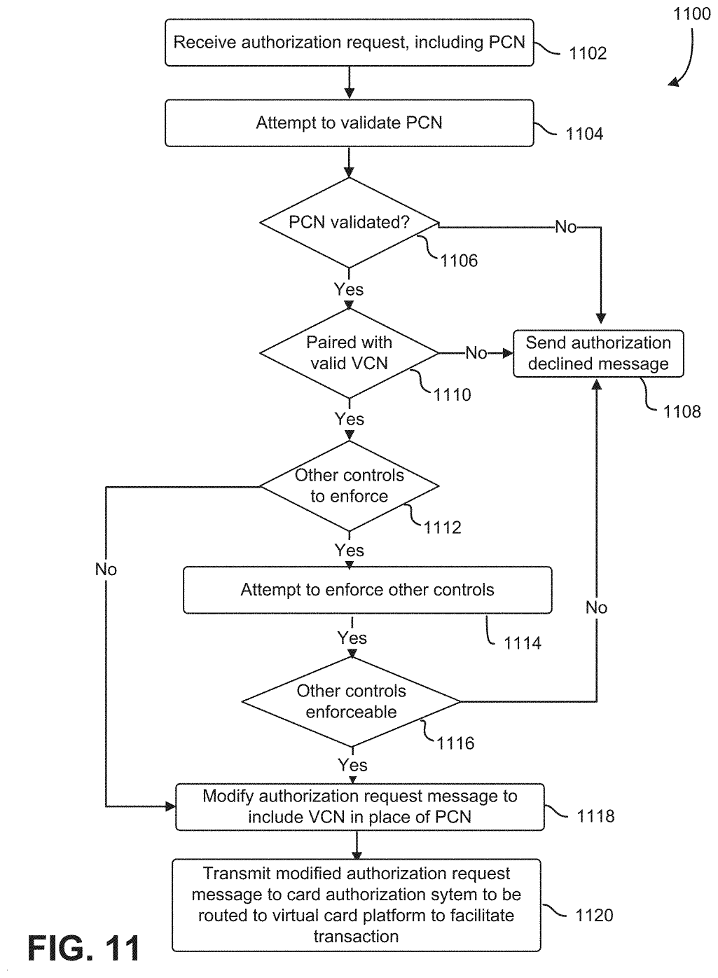

At the network, the first authorization message can be routed to the card conversion platform 318 based on the PCN BIN range, at operation 326. This routing may have been configured prior to the distribution of the PCN cards. The card conversion platform 318 can validate the PCN details contained in the transaction message, including one or more of: is the expiration date correct, is the PIN valid (for PIN enabled transactions), is the CVV valid, is the PCN not blacklisted (due to fraud), is the PCN paired with a VCN, is the PCN enabled, are any PCN specific authorization rules satisfied (the ability to put virtual card type controls on the PCN specifically), and is the merchant “reasonably” close to a previous known mobile device location. This last example, for example, could block transactions that occur more than a configurable distance, such as 100 miles, from the last known location of the mobile device that is associated with the VCN or PCN, or both, as a security precaution. One or more of these operations or checks, which include determining that a PCN is paired with a VCN, may be represented by operation 328. A more detailed example of validating the PCN will be described in greater detail below in reference to FIG. 11. In some cases, operation 328 may include the PCN to VCN search engine 320 determining if the PCN is linked to a VCN, by accessing a PCN data store 324.

Once all the validations are passed successfully, the card conversion platform 318 may swap the paired VCN for the PCN, at operation 328. The card conversion platform 318 may then store the VCN in data fields of the message, and can create a second ISO8583 Message, referred to here as the second authorization message, which can be submitted to the network authorization engine 312, at operation 330. The car authorization system or network 310 can then route this second authorization message according to the existing VCN BIN range routing to the correct virtual card platform 314 (e.g.: ICCP/VPA/e/VPP) that created the VCN, at operation 332. The authorization flow with respect to this second authorization message can operate in the ordinary course—the network 310 can already be configured to route these VCN numbers. The virtual card platform 314 can then associate the VCN to the correct Registered Card Number (RCN), which can be the underlying funding account, at operation 334. A further step of the authorization flow can include routing the second authorization message, which can now contain the RCN associated with the VCN, to the issuing processor (e.g., TSYS/FirstData)/bank processing platform 316, for final authorization, at operation 336. In various embodiments, if any of the authorization or control checks fail at any point from PCN to VCN to RCN, the transaction will be declined and the message indicating a failure can be routed back up the chain to the merchant 302.

FIG. 4 illustrates an example process 400 for processing and delivering a response message from a bank processing platform, such as bank processing platform 314, for example, that may be performed after process 300, such as after operation 336. In the event the authorization is successful, the issuing processor//bank processing platform 316 sends a response message back to the virtual card platform 314, at operation 402, with the RCN. The virtual card platform 314 may then swap the RCN back for the VCN, at operation 404, and route the response back to the card authorization system 310, at operation 406, in reverse of the original flow of the second authorization message. From here, the card authorization system 310 can route the second authorization message response back to the card conversion platform 318 that submitted the message, at operation 408. The card conversion platform 318 can swap the VCN back to the PCN, at operation 410, and this second authorization message can result in a response back to the original loop of the card authorization system 310 that was initiated by the first authorization message, at operation 412. From here, the card authorization system 310 can send the first authorization message authorization response back to the merchant's acquiring processor, which can pass the successful transaction message response to the merchant 402, at operation 414. In some embodiments, merchant and processor will only ever see the PCN—both the VCN and RCN can completely obscured in this process in various examples. This can increase the security of these important account numbers and reduce exposure to undesirable access to these numbers.

In some examples, communications for closing and settlement, as known in the art, may utilize a similar process as descried above in reference to FIGS. 3 and 4 for converting a PCN to a VCN and then to an RCN, and in reverse, by converting an RCN to a VCN and a VCN to a PCN, to finalize the transaction and confirm with the merchant. In some aspects, closing and settlement process may exclude the PCN validation steps described above.

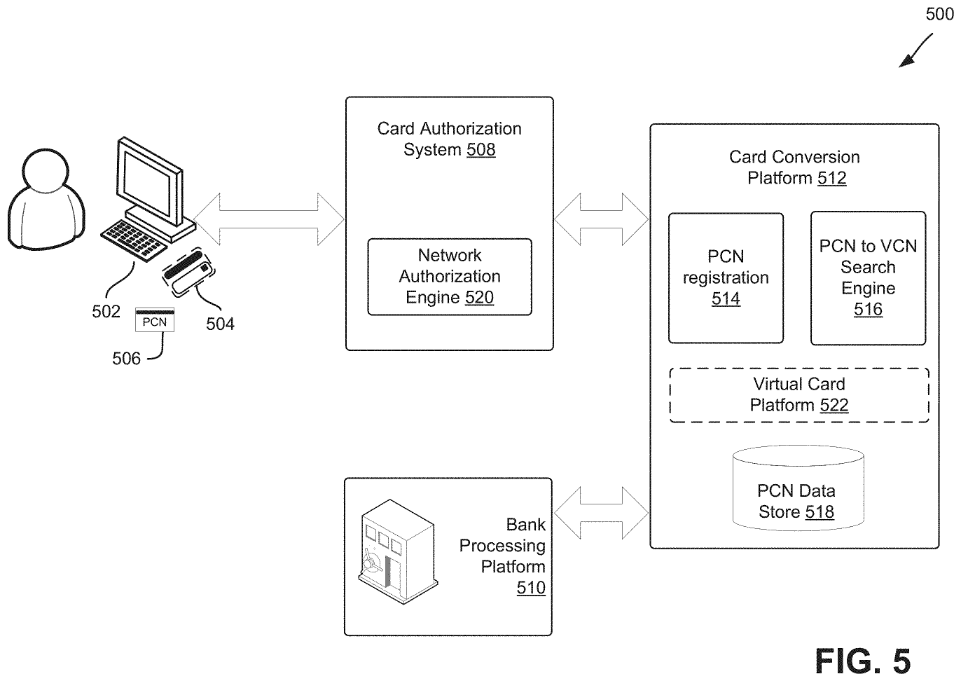

In other examples, as is illustrated in system 500 of FIG. 5, the card conversion platform 512 may include or execute a virtual card platform or process 522 that generates and maintains VCNs, thereby streamlining the authorization process by eliminating, in some examples, the need for the second loop in the authorization flow of process 300 and 400, and also creating a virtual card engine 522 that can replace the need for other third party virtual card engines, such as virtual card platform 222 of system 200 described above in reference to FIG. 2. In this example, upon receiving an authorization request including a PCN 506 scanned by card reader 504 at POS terminal 502, instead of sending the authorizing message back to the card authorization system 208, with the VCN, which would then forward the message to the virtual card platform 222 as described in reference to FIG. 2, the card conversion platform 512 of system 500 may utilize virtual card platform 522, and send the request directly to the bank processing platform 510, without going through the card authorization system 508.

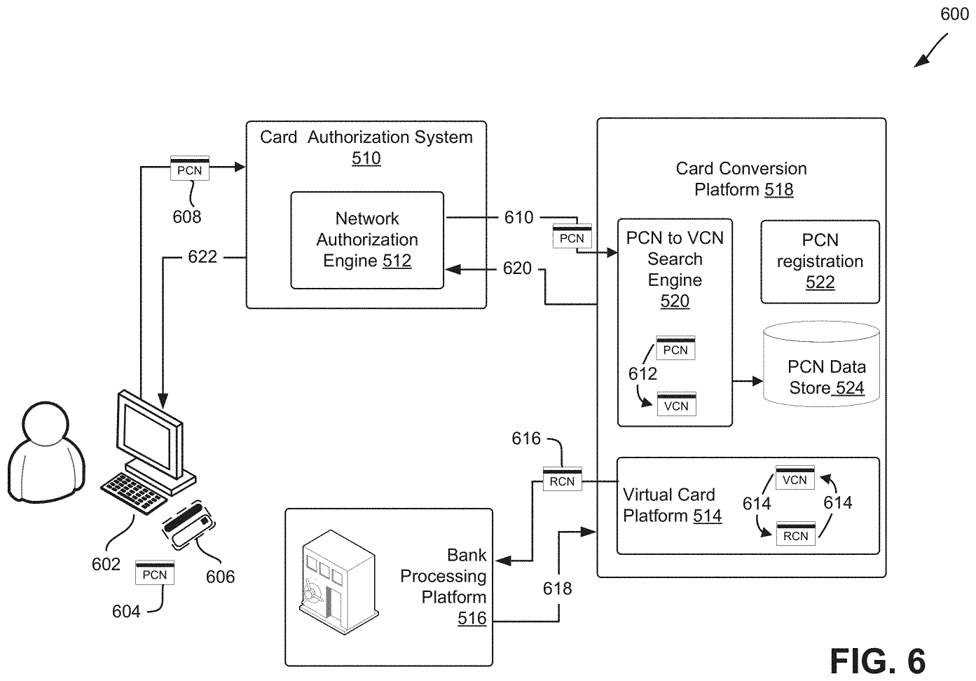

FIG. 6 illustrates example processes of account authorization using a card conversion platform, such as implemented in system 500, described above in reference to FIG. 5. One or more of authorization system 510, network authorization engine 512, virtual card platform 514, bank processing platform 516, card conversion platform 518, PCN to VCN search engine 520, PCN registration 522, and/or PCN data store 524 may include one or more aspects of similar named components of systems 200 and/or 500 described above, and for the sake of brevity, will not be described again here.

As illustrated, process 600 may begin by a PCN 604 being scanned by scanner 606 at a POS terminal 602 to process a transaction. The PCN 604 may be communicated at operation 608 to a card authorization system 510. A network authorization engine 512 of the card authorization system 510 may obtain the PCN 604, and based on one or more characteristics of the PCN 604, such as a range of part or all of the PCN itself 604 or other attributes associated with the PCN 604, such as associated with the PCN in a database, may then send the PCN 604 and an authorization request message at operation 610 to the card conversion platform 518.

As similarly described above in reference to system 200 and/or processes 300 and 400 above, the card conversion platform 518, through a PCN to VCN search engine 520 and a PCN data store 524, may determine a VCN associated with the PCN, at operation 612. Process 600 may differ from processes 300 and 400 in that in process 600, a virtual card platform 514 may be associated with and/or provided or executed by the card conversion platform 518. In this scenario, the VCP 514 may determine an underlying account number and/or other information (e.g., RCN) associated with the VCN at operation 614 (and perform the reverse conversion as well), without having to communicate back and forth with a VCP or process that is remote to the card conversion platform 518. Upon identifying the RCN or other account information, the VCP 514/card conversion platform 518 may communicate that information, along with the authorization request (e.g., amount, type of goods or services associated with the transaction, etc.) to an appropriate bank processing platform 516, at operation 616.

The bank processing platform 516 may identify the account and determine if there are enough funds to authorize the transaction/make sure no other restrictions would prevent authorization of the transaction. The bank processing platform 516 may then send an authorization response message, at operation 618, back to the card conversion platform 518. The card conversion platform 518 may then forward the message/process the message to the card authorization system 510/network authorization engine 512 at operation 620, which may subsequently communicate with the POS terminal 602 to approve or deny the transaction, at operation 622.

In other examples, the card conversion platform 518/VCP 514 may only identify/determine the VCN and communicate that information to the bank processing platform 516, which may in turn identify the underlying account information based on the VCN. In this way, the underlying account information (e.g., RCN) may not be communicated outside of the bank processing platform 516 to increase data security.

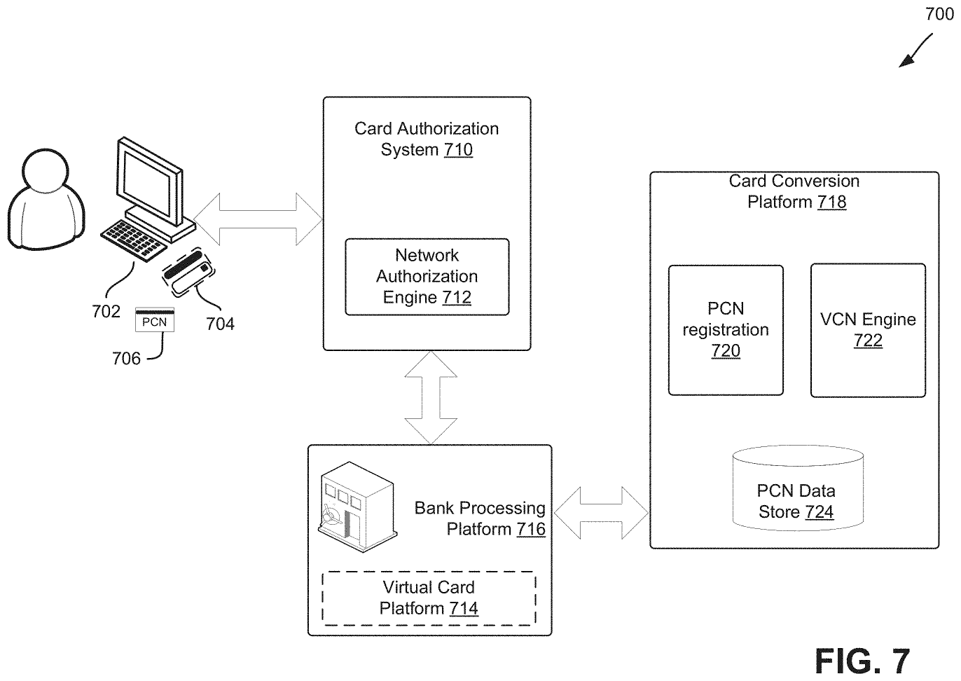

FIG. 7 illustrates another example system 700 that converts a plastic card number 706 to a virtual card number and accesses an account linked to the virtual card number, for example, through a merchant POS terminal 702 including a card reader 704. One or more of authorization system 710, network authorization engine 712, virtual card platform 714, bank processing platform 716, card conversion platform 718, VCN engine 722, PCN registration 720, and/or PCN data store 724 may include one or more aspects of similar named components of systems 200 and 500 described above, and for the sake of brevity, will not be repeated here.

In system 700, the virtual card platform 714 may be implemented or executed by the bank processing platform 716. In this implementation, the card authorization system 710 may communicate directly with the bank processing platform 716, as is normally done with PCNs. The bank processing platform 716 may then, upon receiving an authorization request message including a PCN from the card authorization system 710, determine that the PCN is associated with a VCN, and communicate with the card conversion platform 718 to obtain additional information with respect to the VCN. In some cases, the bank processing platform 716 may communicate with the card conversion platform 718 to authorize the transaction according to any restrictions or limits placed on the VCN by the card conversion platform 718. In some cases, this implementation may further reduce communications needed between the different entities to facilitate a transaction, and/or may increase data security by having all the processing with respect to the RCN or underlying account information handled by the bank processing platform 710.

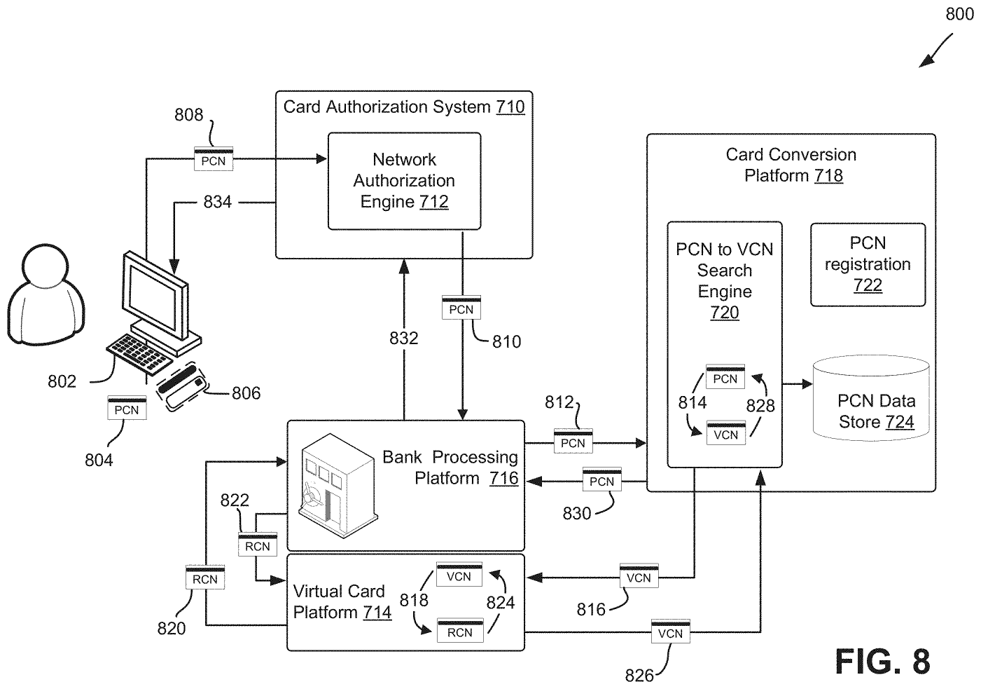

FIG. 8 illustrates an example process of account authorization using a card conversion platform, such as implemented in system 700, described above in reference to FIG. 7. One or more of authorization system 710, network authorization engine 712, virtual card platform 714, bank processing platform 716, card conversion platform 718, VCN engine 720, PCN registration 722, and/or PCN data store 724 may include one or more aspects of similar named components of system 200, 500, and/or 700 described above, and for the sake of brevity, will not be described again here.

As illustrated, process 800 may begin by a PCN 804 being scanned by scanner 806 at a POS terminal 802 to process a transaction. The PCN 804 may be communicated at operation 808 to a card authorization system 710. A network authorization engine 712 of the card authorization system 710 may obtain the PCN 804, and may then send the PCN 804 and an authorization request message at operation 810 to the bank processing platform 716. Based on one or more characteristics of the PCN 804, such as a range of part or all of the PCN 804 itself or other attributes associated with the PCN 804, such as associated with the PCN in a database, the bank processing platform 716 may determine that the PCN is associated with a VCN. The bank processing platform 716 may subsequently send the PCN at operation 812 to the card conversion platform 718. The card conversion platform 718 may then determine a VCN associated with the PCN at operation 814 and any restrictions associated with the VCN, as described above and send the VCN to the virtual card platform 714 (VCP), either directly or through bank processing platform 716 at operation 816.

The bank processing platform 716 may communicate the VCN to a virtual card platform 714 (VCP). The VCP 714, which may be provided by the bank processing platform 716 or separate from the bank processing platform 716, such as provided by a different service, host computing machines, etc., may then determine an underlying account, such as indicated by an RCN that is linked to the VCN, at operation 818. The VCP 714 may then communicate the RCN at operation 820 to the bank processing platform 716. The bank processing platform may then determine whether to approve or deny the transaction based on the request and the underlying account indicated by the RCN.

The bank processing platform 716 may then communicate the approve or deny message back to the POS terminal 802 in a reverse order. This may include the bank processing platform 716 communicating an approve or deny message, with the RCN, at operation 822 to the VCP 714, which may in turn convert the RCN back to the corresponding VCN, at operation 824. The VCP 714 may then route the VCN with the approve or deny message back either directly or through the bank processing platform 716 to the card conversion platform 718a, at operation 826, which may convert the VCN back to the PCN used to initiate the transaction, at operation 818. The card conversion platform 718 may route the PCN and the approve or deny message back through the bank processing platform, at operation 830, to the card authorization system 710, at operation 832, ultimately back to the POS terminal, at operation 834, to approve or deny the transaction.

As illustrated and described above, VCP 714 may be separate from bank processing platform 716, such as provided by a different entity or organization, provided by different computing devices or hosts, etc. In other cases, the VCP 714 may be associated with, part of, or provided by or through the bank processing platform 716, such that operations 820 and 822 may be eliminated or changed in that they would be internal communications between different processes performed by the bank processing platform 716, and operations 816 and 826 may be between the card conversion platform 718 and the bank processing platform 716 rather than as currently depicted as between the card conversion platform 718 and VCP 714.

In yet some examples, the bank processing platform 716, may determine a VCN that corresponds to the provided PCN, prior to communicating with the card conversion platform 718. In this example, the bank processing platform 716 may send the VCN to the card conversion platform 718 to obtain or verify information associated with the VCN and/or PCN. In this example, the card conversion platform 718 may be responsible for enforcing any restrictions placed on the VCN and/or PCN. In some cases, the card conversion platform 718 may provide additional information associated with the VCN to facilitate or enable the bank processing platform 716 to authorize a transaction (e.g., billing address, CVV2, PIN, etc.). Upon receiving the PCN, the card conversion platform 718 may determine relevant information/restrictions (e.g., via the VCN engine 720), and return that information back to the VCP 714/bank processing platform 716.

In some aspects, the card conversion platform may return one or more pieces of information, required by the bank processing platform 716 and/or VCP 714 to determine an underlying account (e.g., RCN) associated with the VCN. In this way data security may be increased, by requiring additional authentication before a transaction can be authorized. The bank processing platform 716 may then determine if the transaction can be authorized, and send an authorization response message to the card authorization system 710. The card authorization system 710 may then communicate with the POS terminal 802 to approve or deny the transaction. In this example, the VCN may still be managed, registered, etc., by the card conversion platform 718. However, the actual conversion between the PCN and VCN may be carried out by the VCP 714/the bank processing platform 716.

It should be appreciated that although operation of a transaction authorization system has been described primary in terms of utilizing a virtual card platform associated with a card authorization system, a card conversion platform, or a bank processing platform, the described techniques can similarly be beneficially implemented using a standalone and/or remote virtual card platform.

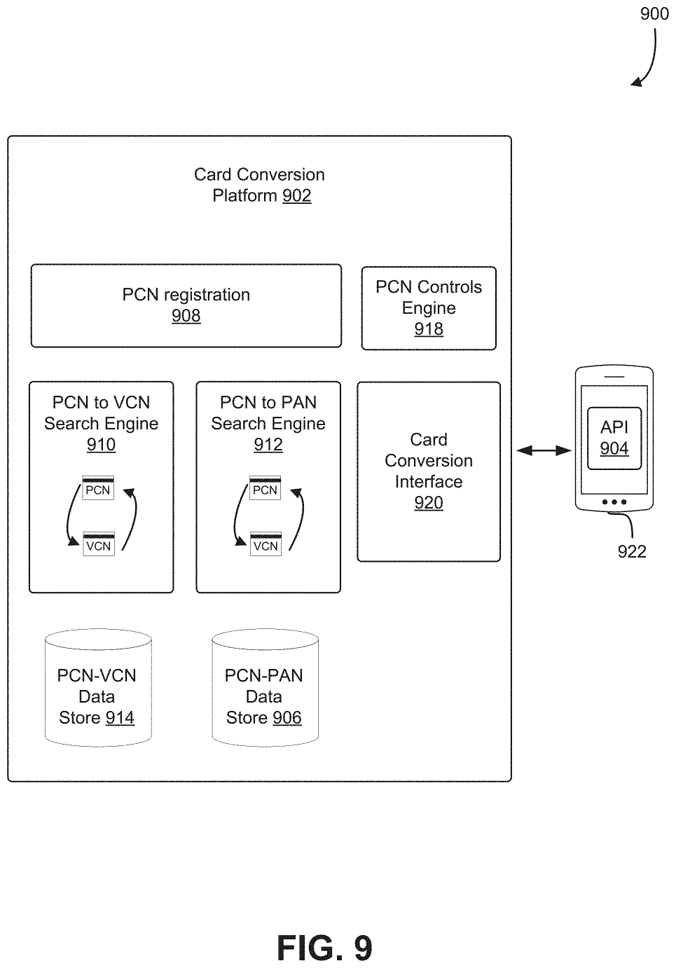

FIG. 9 illustrates a more detailed example of a card conversion platform 900, such as described above in reference to FIGS. 2-8. As illustrated, card conversion platform 902 may interface with an API 904 on another computing device, such as a client mobile device 922. The API 904 may generate and display on device 922 one or more graphical user interfaces that may have controls to enable a client to access various features of the card conversion platform 902, such a registering one or more PCNs and linking it to a VCN or another account number, setting one or more controls on the PCN, and other features, through card conversion interface 920.

The card conversion platform 902 may include a PCN registration component or process 908, which may facilitate registering a PCN with the card conversion platform 902, such as through the card conversion interface 920 and communications with a client API 904. An example process for registering a PCN will be described in greater detail below in reference to FIG. 10. The PCN registration component 908 may maintain a status of each PCN, such as inactive or not associated with any cardholder, credit account or credit line; paired, such that the PCN has been paired to a virtual card number (VCN) or other account number or information, making it “live”; disabled indicating that a paired PCN is turned off for authorizations for a period of time or permanently (it may be re-enabled in the future in some examples); or canceled, which may indicate that the PCN is ineligible for pairing, potentially due to fraud (it may or may not have previously be inactive or paired).

The card conversion platform 902 may also include a PCN controls engine 918, which may facilitate placing and enforcing one or more controls on a PCN. Various suitable controls can be put on a PAN, such as credit limits, merchant control categories, validity dates or times, etc. Such controls can be put on the PCN itself, rather than on the underlying VCN in some embodiments. For example, if an administrator or user wanted to limit all PCNs that it distributes to only airline merchants, it could impose the basic control at the PCN-level, rather than the VCN-level. The PCN engine may associate and maintain indicators of the various controls with the corresponding PCN or PCNs, such as in one or more data structures or databases.

In some aspects, the controls engine 918 may be configured to send notifications to a user, such as via API 904 when configurable events occur with respect to one or more PCNs. For example, a user may configure the card conversion platform 902 via the PCN controls engine 918 to send a notification to the user via API 904 when any transaction occurs or when a subset of transactions occur, such as transactions exceeding one or more value or money limits. In some cases, the controls engine 918 may be configured to require authorization from the registered PCN holder when all or some transactions are detected in real time or near real time, such as exceeding a certain monetary limit, or at certain merchants, unrecognized or new merchants, for certain types of products, and the like. In this example, upon detecting a transaction that has been configured to require authorization, the PCN controls engine 918 may suspend the authorization process (e.g., process 400 described above), and send a request to API 904 to authorize the transaction. Upon receiving an approval from API 904, the PCN controls engine 918 may enable resuming of the authorization process. If the transaction is not approved, a deny message may subsequently be sent from the card conversion platform 902 to the card authorization system and to the merchant. In some cases, the real time or near real time approval of transactions may utilize web hooks to allow authorization. In this case, the card conversion platform 902 can make calls to third parties (which may be configurable by the user, and may be different than the user or administrator) to allow/deny authorizations in real time. A third party can register a web hook endpoint which can be called for every PCN transaction, giving an authorization status depending on transaction metadata.

In some aspects, the PCN controls engine 918 may enable grouping of a number of PCNs (e.g., for a corporate account), to facilitate applying and configuring controls on a much bigger scale, thus reducing the amount of user input needed to configure the controls. This may include setting spending limits on a number of PCN's at once, flagging certain merchants or merchants types or amounts to require administrator approval before allowing the transaction to proceed.

The card conversion platform 902 may include as described above in more detail, a PCN to VCN search engine 910 that may be configured to search for VCNs that are linked to PCNS, using a PCN-VCN data store 914. In some aspects, other card numbers or accounts (e.g., a primary account number of PAN) may additionally or alternatively be linked to a PCN. This may include linking a PCN with a PAN directly, linking one PCN to another PCN (for example to enable multiple tiers of controls to be placed on different groups of PCNs), and so on. This may be facilitated by a PCN to PAN search engine 912 or process, accessing a PCN to PAN data store 906, in a similar way as VCNs may be accessed and linked.

Rather than pairing a PCN to only VCNs, it is possible to pair a PCN to a PAN (in other words, the number on a traditional plastic card that is a “live” account of record). An example use case for pairing a PCN to a PAN would be to create temporary use plastic cards that could be used on a trip abroad, rather than taking the original plastic card. In this way, the PCN can still allow you to use your PAN as if you were using the original plastic card, but without the risk of exposing the PAN printed on the original card. Once finished with the trip or other temporary use case, the PCN can simply be unpaired from the PAN, and the original PAN could be sues as normal.

A second example would be to allow someone (e.g., an employee) to access a PAN without having to share the original card or other details. In the event the original card or PAN was shared, the account holder may lack any ability to control what gets charged to the card. By sharing only a PCN, the receiver can still have access to the full credit line behind the PAN, but with the ability of an administrator to monitor and potentially stop any transactions from happening on that PAN.

In some cases, the PCN may represent or be associated with a credit card, a debit card, a gift card, etc. This may be facilitated by utilizing PCNs that are in ranges typically associated with different types of cards/different banking institutions, etc. In some cases, existing mapping may be utilized, and PCNs may be generated within preexisting ranges of BIN numbers. In other cases, the BIN ranges may be adjusted to account for the new PCNs. In the case that debit cards, pre-funded cards, and the like, are linked, they may similarly be used to the extent they operate on the basis of PANs. One example would be to serve the underbanked, starting with a PCN that is paired to a pre-funded account where the user must put money into an account before being able to use the card. In the future, the PCN can be “upgraded” to be paired with a debit account, once the user qualifies for a bank account, and “upgraded” once again to a credit account once the user establishes a credit history, which in various examples can be without the need for the user to have to change the PCN that he or she first received.

With the participation of the issuing banks and other companies that offer gift cards on j-hooks in stores, instead of a need to distribute inactive PCNs, an existing plastic card already available on a j-hook (or other location) in a store can be repurposed to be paired with a VCN. This can alleviate the need to distribute inactive PCNs in some embodiments. For example, a disaster-relief worker at the site of a disaster could get the necessary ability to pay for supplies by going to the nearest convenience store, obtaining any gift card of a company that participates with the card conversion platform in allowing this repurposing, and then pairing that gift card to a VCN.

In some embodiments, clearing messages can have a timestamp for the original authorization. In such examples is can be possible to change PCN/VCN pairing after an authorization and before a clearing, because the card conversion platform 902 will be able to determine what time the authorization took place and could clear it with the VCN that was paired at the time of the authorization. This may be by the PCN controls engine 918, for example, communicating with the API 904 of a user or administrator device 922.

In some embodiments, endpoints, such as client devices interfacing with the card conversion platform 902 may live outside the reach of network of the platform 902. In these and other cases, the card conversion platform 902 may be implemented as a standalone internal system application that one or more APIs 904 may interface with. These endpoints can live on internal client computing systems, and may utilize the similar processes as described above.

FIG. 10 illustrates an example process 1000 for registering and paring an account with a virtual card number, as may be performed by a card conversion platform as described above.

In order to pair a PCN to a VCN in one example, the user can download and use an application via a mobile phone, camera-equipped computer, or the like. There can be a unique QR code with encrypted PCN/CVV/Expiration Date in the package of the PCN in various examples. A user who obtains a PCN and wants to pair it to a VCN can take a picture of this QR code and upload it to the card conversion platform, for example with or as a request to pair the PCN. This may represented by operations 1002 and 1004 performed by the card conversion platform. In some cases, a separate request, such as at operation 1002 may not be needed. The user can then receive a VCN number from any an enabled cardholder to which the PCN can then be paired. The user may submit this VCN, and it may be received or obtained by the card conversion platform, at operation 1006. In further examples, rather than taking a picture, pairing can be by manual entry, contactless functionality, or the like. In some aspects, when the VCN is already linked to the cardholder, the card conversion platform may interface with a virtual card platform (e.g., external or hosted by the card conversion platform) to obtain the VCN automatically.

Pairing a PCN to a VCN can involve sending both the PCN and the VCN, along with associated metadata for validation, (e.g., operation 1002-1006) via an API, which may be referred to as a REST API, such as API 604 described above, to the card conversion platform. The PCN info may be associated with the QR code and/or may be obtained by reading or scanning the magnetic strip or chip of the card itself. In some cases, the PCN, expiration date, CVV2 and other security and account information may be encoded or encrypted, such that only the REST API and/or card conversion platform may be able to decrypt the information and obtain the underlying account card information. The information may take the form of a token, in some aspects. In some aspects, a separate Pin or code may be required to activate a PCN, such as may be associated with the card and accessed via the REST API, or via other means.

The card conversion platform can then attempt to validate whether the PCN and VCN are allowed to be paired, at operation 1008. If all validation checks are passed, as determined at operation 1010, the two numbers can be paired such that when the PCN is swiped at the POS, the associated VCN is used for authorization, at operation 1012. Once successfully paired, the cardholder can have the ability use a VCN at a physical POS terminal, which in some examples can solve a major challenge in the wider adoption of VCNs.

In some aspects, operations 1008 and 1010 may include verifying one or more of the following inquires with respect to the PCN and the VCN or other number to be paired:

### PCN

1. Is PCN PAN within the BIN range to be routed to Extend pre-processor?
2. Is expiration date correct?
3. Has PCN not already been paired?
4. Has PCN not been previously paired?
5. Has PCN not been blacklisted?
6. Does the scan of the PCN QR code convey the correct encrypted PCN/PAN, CVV and Expiration Date?
7. Is the location of the device utilizing the application within “reasonable” parameters to previous known locations of that device?

### VCN

1. Does the VCN exist?
2. Is the VCN within the correct BIN range?
3. Is the VCN not already paired (possible to pair multiple PCN with a single VCN?)
4. Does user have permission to the VCN?
5. Is the CVV correct?
6. Is the expiration date correct?
7. Send code to email on file to verify registration
8. Is the VCN not blacklisted?
9. Is pairing to a PCN allowed for that VCN?

In some aspects, operation 1010 may only indicate that the pairing is validated if each of the inquiries above is validated satisfactorily. In other aspects, a subset of the queries may be presented, and/or some queries may not to be validated or determined in the positive to enable the pairing. It should be appreciated that the above inquiries are only given by way of example, and that additional or fewer inquiries may be used to a similar effect, with those variations being contemplated herein.

Pairing a PCN to a VCN can offer other advantages over a traditional plastic card when used in person at a POS terminal in various embodiments. For example, the plastic card itself may have no information printed on it. In another example, even if someone were to gain access to information that may be encoded in the PCN, the paired VCN information can still remain unknown and secure, with the ability of the user or administrator to instantly cancel that PCN, effectively unpairing it from the VCN. This can be done in some examples via the application rather than needing to contact the card company to cancel the compromised card. Canceling a PCN has no impact on the VCN it is or was associated with in various embodiments, so the VCN information can remain unknown and secure. Accordingly, in various examples, any information regarding the VCN is never revealed to a party in a PCN transaction.

If the pairing is not validated, at operation 1010, process 1000 may end at operation 1014. Alternatively, the user may be given a number of retries to enter the information or attempt to pair a different PCN and/or VCN, such that process 1000 may loop from operation 1010 to operation 1002 a number of times, for example, until a maximum amount of pairing attempts are received, which point process 1000 may end and lock user out, for example.

In some cases, if PCN cardholders want to make card-not-present (CNP) transactions, they may be required to use the associated VCN directly, since the PCN, CVV2, and Expiration Date of the PCN may not be visible to the cardholder in various examples.

In some aspects, process 1000 may also be used to pair a PCN with a PAN, another PCN, and so on, by simply replacing the VCN with the appropriate number of account indicator to be paired.

FIG. 11 illustrates an example process 1100, performed by a card conversion platform as described above, for facilitating authorizing an account request. Process 1100 may be an example of operations performed by the card conversion platform described above in reference to processes 300, 400, 600, and/or 800.

Process 1100 may begin by, for example, the card conversion platform receiving an authorization request that includes a PCN, at operation 1102. Next, the card conversion platform may attempt to validate the PCN, at operation 1104. This may include checking to see that the expiration date is correct and valid, that an associated PIN is valid (for PIN enabled transactions), that a CVV2 code is valid, and/or other checks to ensure that PCN is authorized for the transaction. In some cases, operation 1104 may include verifying an active or paired status of the PCN (out of inactive, paired, disabled, or canceled, to ensure that, for example, the PCN is not blacklisted (e.g., due to fraud). Checking status of the PCN may include verifying the PCN status with a PCN registration component described above.

If the PCN is validated, as determined at operation 1106, the card conversion platform may determine if the PCN is paired with a valid VCN, at operation 1110. This may include searching for a paired VCN by a PCN-VCN search engine in a PCN data store, as described above. If either of the determinations at operations 1106 or 1110 are negative, process 1100 may proceed to operation 1108, where an authorization decline message may be generated and sent to the card authorization system to be forwarded to the requesting merchant.

If both the PCN is validated and the PCN is determined to be paired with a valid VCN, then process 1100 may proceed to operation 1112, where it may be determined if any other controls are associated with the PCN and/or in some cases, the VCN. If there are other controls, as may be maintained by a PCN controls engine, as described above, those controls may be attempted to be enforced, by the PCN controls engine, at operation 1114. If the controls can be enforced, within the confined of the requested transaction, then the card authorization platform may modify the authorization request message and include the linked VCN in place of the PCN, at operation 1118. The card conversion platform may then transmit the modified request authorization message to the card authorization system, at operation 1120, to be routed to the virtual card platform to facilitate the transaction.

In aspects where the card conversion platform provides its own virtual card platform (e.g., generating and maintaining VCNs), the card conversion platform may look up the underlying account information (e.g., RCN) and instead of replacing the PCN with the VCN at operation 1118, may instead replace the PCN with the RCN, and send the modified response directly to the bank processing platform, in place of operation 1120.

In the event one or more controls are not enforceable, as determined at operation 1116, process 1100 may proceed to operation 1108, where an authorization declined message may be generated and sent. In the event no other controls are associated with the PCN, at operation 1112, process 1100 may proceed directly to operation 1118.

As descried above, the additional controls may include a transaction amount limit (one time, over a period of time, etc.), merchant limits, merchant type limits (e.g., gas and food), distance or location based limits (e.g., that the transaction is occurring within a certain distance of a device registered to the account, where it was issued or activated, etc.), and so on. In some aspects the authorization request message may take one of various forms to interface with appropriate card authorization systems and/or appropriate bank processing platforms. In some cases, the authorization message may include an identical ISO8583 message.

In some aspects, card conversion platform may receive the authorization response message back from the card authorization system. In this scenario, the card authorization system may exchange the VCN for the PCN and resubmit the message back to the card authorization system.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A computer implemented method, the method comprising:
receiving, at a card conversion platform, an authorization request from a point of sale terminal through a card authorization system, the authorization request comprising a plastic card number;
determining a virtual card number based on the plastic card number, wherein the plastic card number is registered with a data store, and wherein the plastic card number is associated with the virtual card number in the data store;
determining at least one restriction on the plastic card number based on at least one restriction associated with the virtual card number;
determining to conditionally approve or deny the authorization request based on comparing the authorization request with the at least one restriction on the plastic card number;
upon determining to conditionally approve the authorization request, replacing, in the authorization request, the plastic card number with the virtual card number to generate a modified authorization request; and
routing the modified authorization request to a bank processing platform to approve or deny the authorization request based on a primary account associated with the virtual card number.

2. The computer-implemented method of claim 1, further comprising converting, by the card authorization system, the virtual card number to a primary account number upon receiving the modified authorization request.

3. The computer-implemented method of claim 1, further comprising: routing the modified authorization request to the bank processing platform through the card authorization system.

4. The computer-implemented method of claim 1, further comprising converting, by the card conversion platform, the virtual card number to a primary account number.

5. The computer-implemented method of claim 1, further comprising converting, by the bank processing platform, the virtual card number to a primary account number.

6. The computer-implemented method of claim 1, wherein the authorization request is routed through the bank processing platform prior to being received by the card conversion platform.

7. The computer-implemented method of claim 1, further comprising:
routing the modified authorization request to the bank processing platform through a virtual card platform; and
converting, by a virtual card platform, the virtual card number to a primary account number, wherein the virtual card platform stores or accesses a second data store comprising a plurality of virtual card numbers associated with a plurality of primary account numbers.

8. The computer-implemented method of claim 1, wherein the at least one restriction on the plastic card number comprise at least one of a spending limit of the authorization request, at least one type of goods or services of the authorization request, a time period of the authorization request during which transactions are authorized, or a time of day of the authorization request.

9. The computer-implemented method of claim 1, further comprising:
receiving a request to associate the plastic card number with the virtual card number, wherein the request comprises the at least one restriction on usage of the plastic card number; and
associate the virtual card number with the plastic card number and the at least one restriction and store the association in the data store.

10. The computer-implemented method of claim 1, further comprising:
receiving a request to associate the plastic card number and a second plastic card number with the virtual card number, wherein the request comprises the at least one restriction on usage of the plastic card number and at least one second restriction on usage of the second plastic card number; and
associate the virtual card number with the plastic card number and the at least one restriction, and the second plastic card number and the at least one second restriction, and store the association in the data store.

11. A system, comprising at least one computing device configured with processors and memory, the memory including instructions that upon execution cause the system to:
receive, at a card conversion platform, an authorization request, the authorization request comprising a plastic card number;
determine a virtual card number based on the plastic card number, wherein the plastic card number is registered with a data store, and wherein the plastic card number is associated with the virtual card number in the data store;
determine at least one restriction on the plastic card number based on at least one restriction associated with the virtual card number;
determine to allow the authorization request based on comparing the authorization request with information associated plastic card number in the data store; and
upon determining that the authorization request is allowed, route a modified authorization request to a bank processing platform to approve or deny the authorization request based on a primary account associated with the virtual card number, wherein the modified authorization request comprises the virtual card number.

12. The system of claim 11, wherein the memory includes additional instructions that upon execution cause the system to:
receive a request to associate the plastic card number with the virtual card number, wherein the request comprises at least one restriction on usage of the plastic card number; and
associate the virtual card number with the plastic card number and the at least one restriction and store the association in the data store.

13. The system of claim 12, wherein the at least one restriction on the plastic card number comprise at least one of a spending limit of the authorization request, at least one type of goods or services of the authorization request, a time period of the authorization request during which transactions are authorized, or a time of day of the authorization request.

14. The system of claim 11, wherein the memory further includes instructions that upon execution further cause the system to provide an interface to a computing device associated with management of the virtual card number, wherein the interface, upon receiving an instruction to modify actions authorized for the plastic card number, changes at least one entry in the data store to modify the a least one restriction associated with the plastic card number based on the instruction.

15. The system of claim 11, wherein the memory further includes instructions that upon execution further cause the system to provide an interface to a computing device associated with management of the virtual card number, wherein upon receiving an instruction to disable the plastic card number associated with the virtual card number, the interface causes one or more values in the data store associated with the plastic card number to indicate that the plastic card number is disabled.

16. The system of claim 11, wherein the memory includes additional instructions that upon execution cause the system to:
receive a request to associate the plastic card number and a second plastic card number with the virtual card number; and
associate the virtual card number with the plastic card number and the second plastic card number and store the association in the data store.

17. A non-transitory computer-readable storage medium having stored thereon executable instructions that, as a result of execution by one or more processors of a computer system, cause the computer system to at least:
receive a request from a point of sale terminal, the request comprising an indication of a requested transaction and a plastic card number;
determine a virtual card number based on the plastic card number, wherein the plastic card number is registered with a service, and wherein the plastic card number is associated with the virtual card number in the data store maintained by the service;
determine to conditionally approve or deny the request based on comparing the request with information associated plastic card number in the data store; and
send a modified request to a bank processing platform to approve or deny the request based on a primary account associated with the virtual card number, wherein the modified request comprises the virtual card number.

18. The non-transitory computer-readable storage medium of claim 17, wherein the virtual card number is associated with a plurality of plastic card numbers including the plastic card number, and wherein individual plastic card numbers of the plurality of plastic card numbers are associated with at least one restriction on usage of the corresponding plastic card number.

19. The non-transitory computer-readable storage medium of claim 17, wherein the executable instructions, as a result of execution by the one or more processors of the computer system, further cause the computer system to at least:
receive a request to associate the plastic card number with the virtual card number, wherein the request comprises at least one restriction on usage of the plastic card number; and
associate the virtual card number with the plastic card number and the at least one restriction and store the association in the data store.

20. The non-transitory computer-readable storage medium of claim 17, wherein the executable instructions, as a result of execution by the one or more processors of the computer system, further cause the computer system to at least convert the virtual card number to a primary account number by accessing a second data store storing comprising a plurality of virtual card numbers associated with a plurality of primary account numbers.
